(19) United States
(12) Patent Application Publication
(10) Pub. No.: US 2025/0058280 A1
(43) Pub. Date: Feb. 20, 2025

(54) Hollow Fiber Membrane Filtration Device

(71) Applicant: KUN SAN CO., LTD., Taoyuan City (TW)

(72) Inventor: Keng An Lu, Taoyuan City (TW)

(21) Appl. No.: 18/452,121

(22) Filed: Aug. 18, 2023

(51) Int. Cl. B01D 63/02

(52) U.S. Cl. CPC B01D 63/0241; B01D 2313/2031; B01D 2313/21

(57) ABSTRACT

A hollow fiber membrane filtration device includes a housing, a hollow fiber membrane module, a supporting tube, and a bottom cover. The housing includes a top wall having a positioning hole intercommunicating with a receiving space of the housing. The hollow fiber membrane module includes a plurality of densely arranged inverted U-shaped hollow fibers. The hollow fiber membrane module is inserted upward through a bottom opening of the housing into the receiving space. The supporting tube is inserted in the fiber membrane seat and extends upright to couple with the top wall of the housing. The supporting tube can be coupled with a filtration seat and a fixing rod which are currently available. The bottom cover is coupled to the bottom opening and includes a flow guiding space having an upwardly facing opening. The bottom cover includes an outlet spaced from the central hole of the supporting tube.

### BACKGROUND OF THE INVENTION

The present invention relates to a filtration device and, more particularly, to a hollow fiber membrane filtration device.

A hollow fiber membrane module generally includes extremely thin hollow fibers in a bundle. A hollow fiber has two opposite open ends permitting passage of larger molecules, and many apertures are formed on a tube wall between the two opposite open ends. The hollow fibers have a high-porosity structure and, thus, can be used on filtration devices to filter polluted particles by tiny apertures.

Currently available hollow fiber membrane filters generally include a hollow fiber membrane module in a receiving space of a housing, and an inlet and an outlet are respectively provided on an upper cover and a lower cover of the housing, such that a fluid can flow through the inlet of the upper cover into the upper open end of each fiber to proceed with filtration, flow through the lower open end of each fiber, and then flow outward via the outlet of the lower cover. The structure of the hollow fiber membrane, the upper cover, and the lower cover cannot be combine with a central fixing rod of a filtration seat currently available on the market. Thus, the use and application of the hollow fiber membrane are restricted. It is, therefore, important to solve the above problem in the art.

### BRIEF SUMMARY OF THE INVENTION

An objective of the present invention is to provide a filtration device using a supporting tube to insert through and couple with a hollow fiber membrane module and the positioning hole at the top end of the housing. Thus, the filtration device can be used to couple with the fixing rod particularly for a filtration seat which is currently available on the market. Furthermore, the filtration stability and airtightness can be maintained while the fluid is in a high pressure state. Therefore, the use and application of the hollow fiber membrane can be extended, permitting easier installation and replacement while achieving the filtration effect.

To achieve the above objective, the present invention comprises a hollow fiber membrane filtration device comprising:
a housing including a receiving space having a bottom opening, wherein the housing further includes a top wall having a positioning hole intercommunicating with the receiving space, and wherein a plurality of inlet holes is spacedly provided on a periphery of the housing and intercommunicates with the receiving space;
a hollow fiber membrane module including a plurality of hollow fibers which are densely arranged, wherein each of the plurality of hollow fibers is substantially inverted U-shaped and includes two open ends facing downwardly and inserted into and fixed to a fiber membrane seat, wherein the hollow fiber membrane module is inserted upward through the bottom opening into the receiving space, and wherein the fiber membrane seat is fixed in the bottom opening;
a supporting tube having a lower end inserted in the fiber membrane seat and extends upright to couple with the top wall of the housing, wherein the supporting tube includes a central hole aligned with the positioning hole of the top wall of the housing, forming a fixing hole for installation, wherein the plurality of hollow fibers is densely distributed around an outer periphery of the supporting tube;
a bottom cover coupled to the bottom opening of the housing, wherein the bottom cover includes a flow guiding space having an upwardly facing opening, and wherein the bottom cover includes a bottom having an outlet facing and spaced from the central hole of the supporting tube,
wherein a fluid is permitted to flow through the plurality of inlet holes of the housing and a periphery of each of the plurality of hollow fibers and infiltrates into an interior of each of the plurality of hollow fibers, and the fluid then flows downward through the two open ends of each of the plurality of hollow fibers into the flow guiding space of the bottom cover and flows downward and outward through the outlet of the bottom cover.

In an example, the housing includes a first inner threading on an inner wall of the bottom opening of the housing. The fiber membrane seat includes a first outer threading on an outer periphery thereof. The first outer threading is in threading connection with the first inner threading.

In an example, the housing includes a second outer threading on an outer periphery of the bottom end of the housing. The bottom cover includes an inner wall having a second inner threading in threading connection with the second outer threading.

In an example, the fiber membrane seat includes an inner ring and an outer ring concentric to and radially outward of the inner ring. The plurality of hollow fibers is juxtaposedly adhered between the inner ring and the outer ring.

In an example, the inner ring of the fiber membrane seat includes an inner side having a third inner threading. A third outer threading is provided on the outer periphery of the supporting tube and is in threading connection with the third inner threading.

In an example, the housing includes an enlarged stepped hole below the positioning hole. A top end of the supporting tube is coupled in the enlarged stepped hole. The central hole of the supporting tube and the positioning hole have the same diameter.

In an example, the hollow fiber membrane filtration device further comprises a filtration seat having a fixing rod disposed in a central portion thereof. The bottom cover is inserted in the filtration seat. The fixing rod extends upward through the outlet of the bottom cover, the central hole of the supporting tube, and the positioning hole of the housing. The fixing rod has an outer diameter matching with the diameters of the central hole of the supporting tube and the positioning hole. The diameter of the outlet of the bottom cover is greater than the outer diameter of the fixing rod.

The present invention will become clearer in light of the following detailed description of illustrative embodiments of this invention described in connection with the drawings.

### DESCRIPTION OF THE DRAWINGS

FIG. 1 is a perspective view of a hollow fiber membrane filtration device of an embodiment according to the present invention.

FIG. 2 is an exploded, perspective view of the hollow fiber membrane filtration device of the embodiment according to the present invention.

FIG. 3 is a bottom view of a hollow fiber membrane and a supporting tube of the hollow fiber membrane filtration device of the embodiment according to the present invention.

FIG. 4 is a cross sectional view of the hollow fiber membrane filtration device of the embodiment according to the present invention.

FIG. 5 is a cross sectional view of a housing of the hollow fiber membrane filtration device of the embodiment according to the present invention.

FIG. 6 is a perspective view of the hollow fiber membrane of the hollow fiber membrane of the embodiment according to the present invention.

FIG. 7 is an exploded, perspective view of a fiber membrane seat and the supporting tube of the hollow fiber membrane of the embodiment according to the present invention.

FIG. 8 is a schematic view illustrating use of the hollow fiber membrane filtration device of the embodiment according to the present invention.

FIG. 9 is a schematic side view of a hollow fiber membrane filtration device of another embodiment according to the present invention.

FIG. 10 is a schematic side view of a hollow fiber membrane filtration device of a further embodiment according to the present invention.

### DETAILED DESCRIPTION OF THE INVENTION

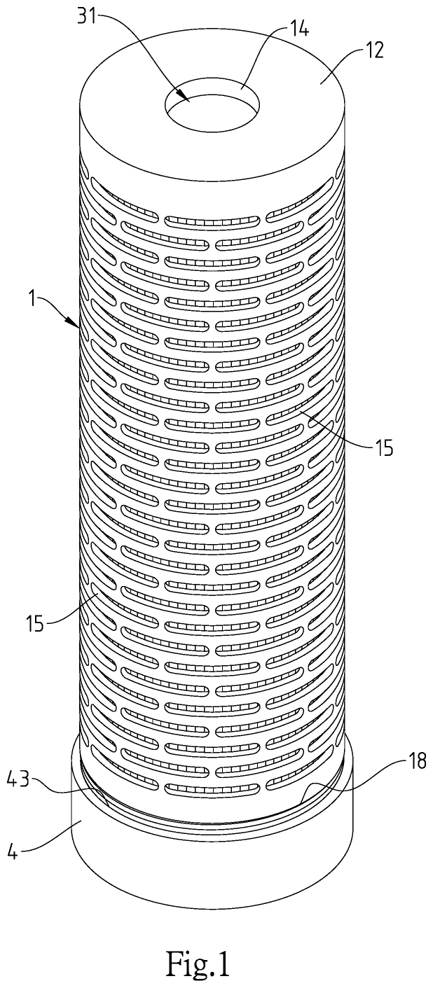

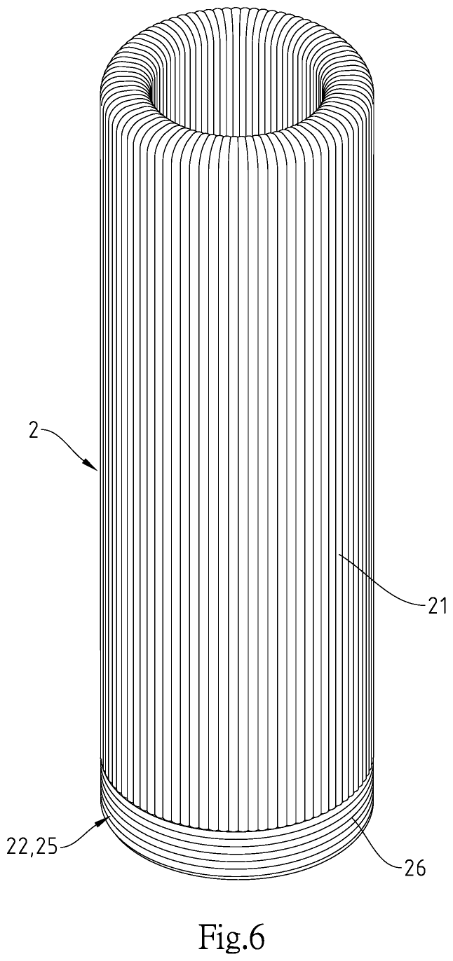

With reference to FIGS. 1-7, a hollow fiber membrane filtration device of an embodiment according to the present invention comprises a housing 1, a hollow fiber membrane module 2, a supporting tube 3, and a bottom cover 4 and is configured to filter a fluid, such as polluted water, waste liquid, etc.

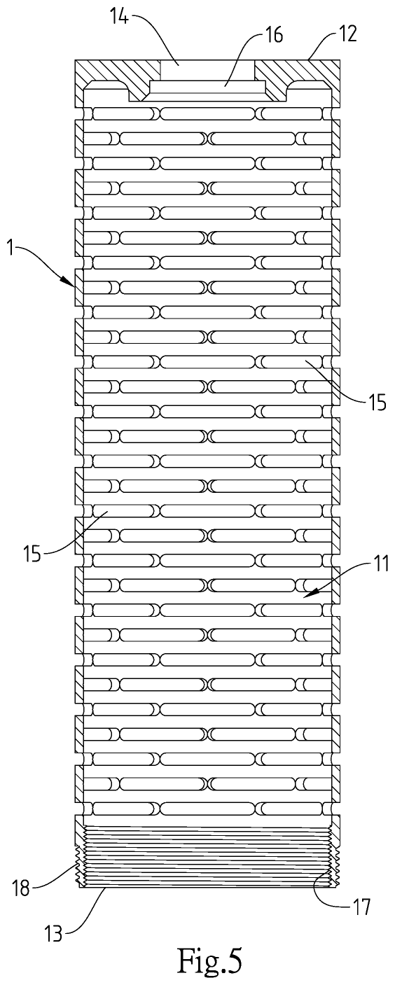

The housing 1 includes a receiving space 11 having a bottom opening 13 (see FIG. 5). The housing 1 further includes a top wall 12 having a positioning hole 14 intercommunicating with the receiving space 11. The housing 1 further includes an enlarged stepped hole 16 below the positioning hole 14. A plurality of inlet holes 15 is spacedly provided on a periphery of the housing 1 and intercommunicates with the receiving space 11. A first inner threading 17 is provided on an inner wall of the bottom opening 13 of the housing 1. A second outer threading 18 is provided on an outer periphery of the bottom end of the housing 1.

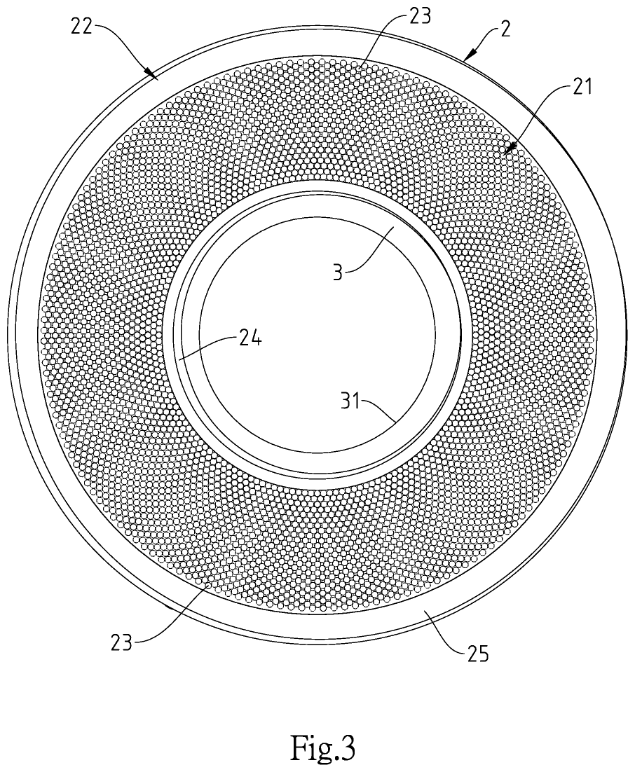

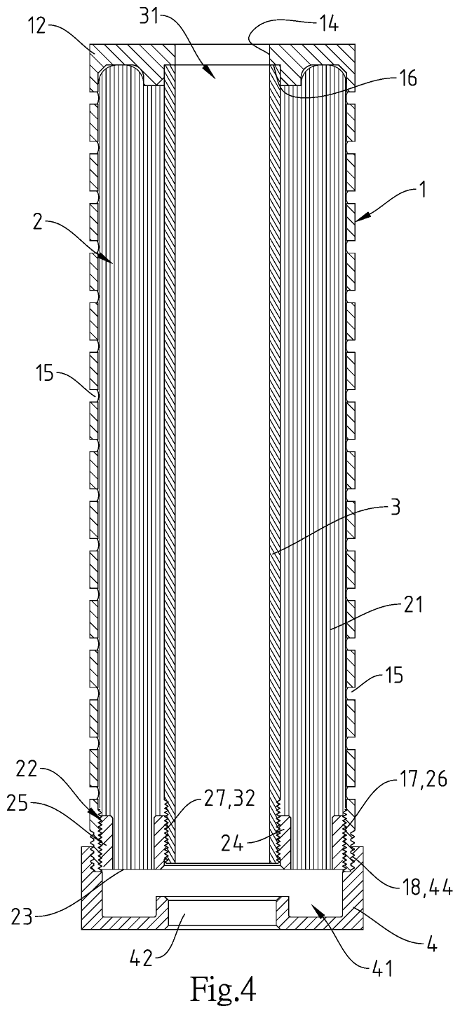

The hollow fiber membrane module 2 includes a plurality of hollow fibers 21 which are densely arranged. Each of the plurality of hollow fibers 21 is substantially inverted U-shaped and includes two open ends 23 (see FIGS. 3 and 4) facing downwardly and inserted into and fixed to a fiber membrane seat 22. The fiber membrane seat 22 includes an inner ring 24 and an outer ring 25 concentric to and radially outward of the inner ring 24. The two ends of each of the plurality of hollow fibers 21 are juxtaposedly adhered between the inner ring 24 and the outer ring 25 to form a fixed structure. The outer ring 25 of the fiber membrane seat 22 includes a first outer threading 26 on an outer periphery thereof. The first outer threading 26 is in threading connection with the first inner threading 17. The inner ring 24 of the fiber membrane seat 22 includes an inner side having a third inner threading 27. The hollow fiber membrane module 2 is inserted upward through the bottom opening 13 into the receiving space 11 of the housing 1. The fiber membrane seat 22 is fixed in the bottom opening 13.

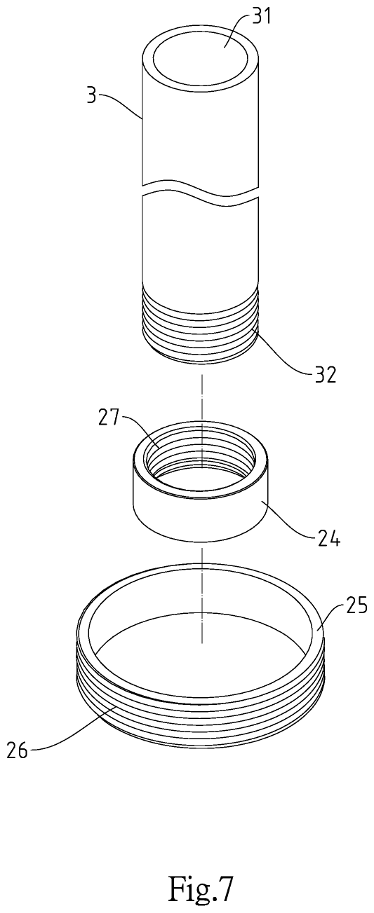

A third outer threading 32 is provided on the outer periphery of the supporting tube 3 and is in threading connection with the third inner threading 27 (see FIGS. 4 and 7). The supporting tube 3 has a lower end inserted in a central portion of the fiber membrane seat 22 and extends upright. A top end of the supporting tube 3 is coupled in the enlarged stepped hole 16. A central hole 31 of the supporting tube 3 and the positioning hole 14 have the same diameter. The central hole 31 of the supporting tube 3 is aligned with the positioning hole 14 of the top wall 12 of the housing 1, forming a fixing hole for installation. The plurality of hollow fibers 21 is densely distributed around an outer periphery of the supporting tube 3.

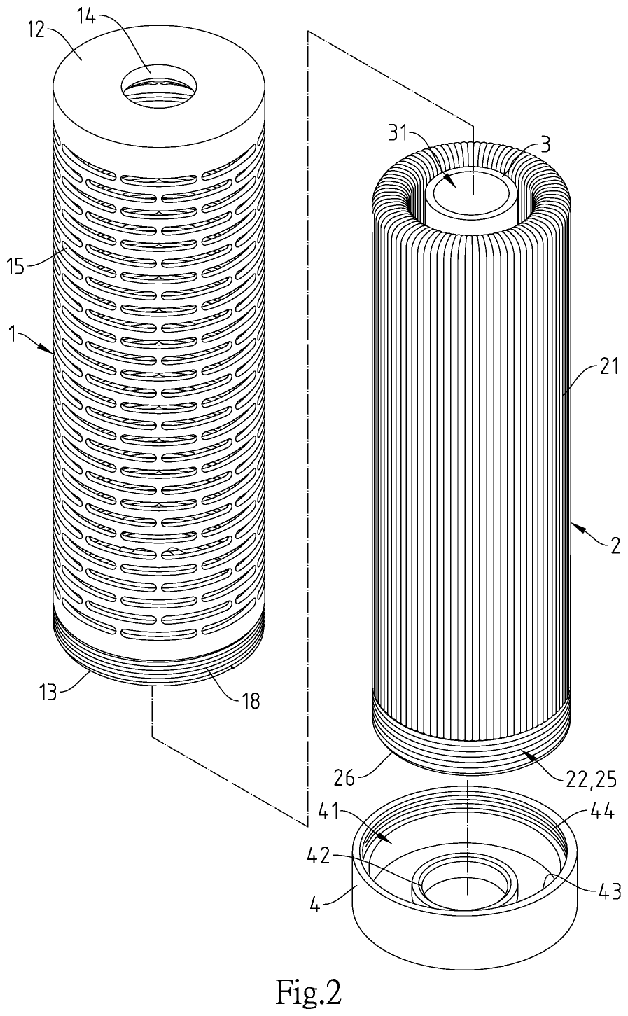

The bottom cover 4 is coupled to the bottom opening 13 of the housing 1. The bottom cover 4 includes a flow guiding space 41 having an upwardly facing opening 43 (see FIGS. 2 and 4). The bottom cover 4 includes an inner wall having a second inner threading 44 in threading connection with the second outer threading 18. The bottom cover 4 includes a bottom having an outlet 42 facing and spaced from the central hole 31 of the supporting tube 3. The housing 1, the hollow fiber membrane module 2, the supporting tube 3, and the bottom cover 4 are assembled to form the hollow fiber membrane filtration device.

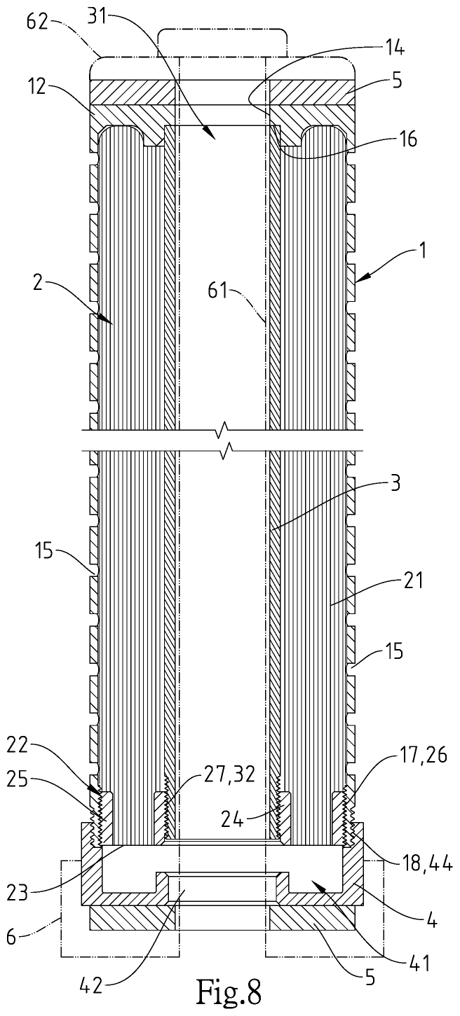

FIG. 8 shows use of the hollow fiber membrane filtration device. The filtration device according to the present invention further comprises a filtration seat 6 having a fixing rod 61 disposed in a central portion thereof. Leakproof washers 5 are provided on the top wall 12 of the housing 1 and the bottom cover 4. The housing 1 and the bottom cover 4 are inserted downward into the filtration seat 6. The fixing rod 61 extends upward through the outlet 42 of the bottom cover 4, the central hole 31 of the supporting tube 3, and the positioning hole 14 of the housing 1, and a fixing cover 62 is used for fixing. The fixing rod 61 has an outer diameter matching with the diameters of the central hole 31 of the supporting tube 3 and the positioning hole 14, and the diameter of the outlet 42 of the bottom cover 4 is greater than the outer diameter of the fixing rod 61.

An external fluid is permitted to flow through the plurality of inlet holes 15 of the housing 1 and a periphery of each of the plurality of hollow fibers 21 and infiltrates into an interior of each of the plurality of hollow fibers 21 for filtration. Next, the fluid flows downward through the two open ends 23 of each of the plurality of hollow fibers 21 into the flow guiding space 41 of the bottom cover 4. Then, the fluid flows downward and outward through the outlet 42 of the bottom cover 4, achieving the filtration purpose. The filtration device according to the present invention uses the supporting tube 3 to insert through and couple with the hollow fiber membrane module 2 and the positioning hole 14 at the top end of the housing 1. Thus, the filtration device can be used to couple with the fixing rod 61 particularly for the filtration seat 6 which is currently available on the market. Furthermore, the filtration stability and airtightness can be maintained while the fluid is in a high pressure state. Therefore, the use and application of the hollow fiber membrane 2 can be extended, permitting easier installation and replacement while achieving the filtration effect.

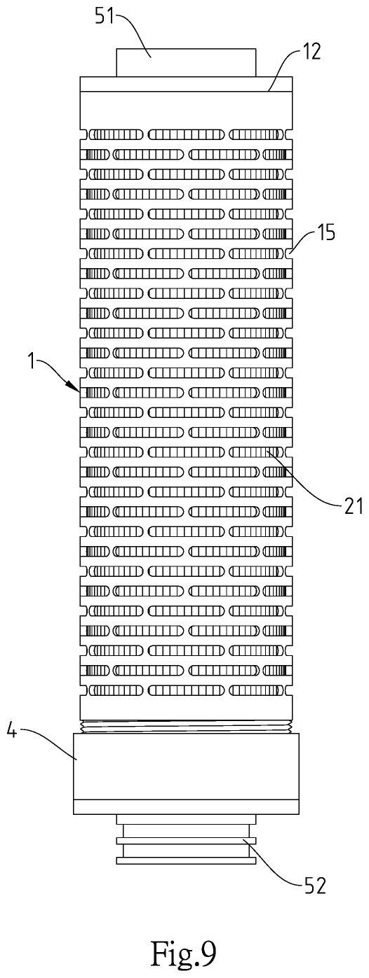

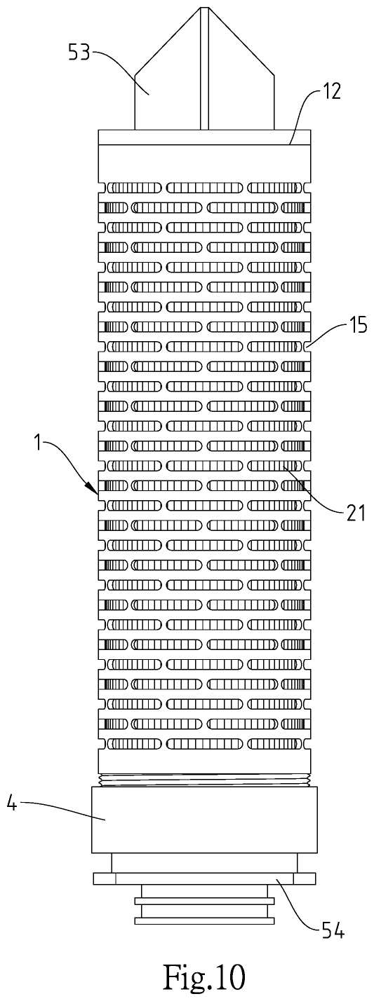

FIG. 9 shows another embodiment of the hollow fiber membrane filtration device. Specifically, a cap 51 is securely disposed on the top wall 12 of the housing 1, and a fitting 52 is securely coupled to the bottom cover 4. FIG. 10 shows a further embodiment of the hollow fiber membrane filtration device. Specifically, a plug 53 is securely disposed on the top wall 12 of the housing 1, and a fitting 54 is securely coupled to the bottom cover 4.

Although specific embodiments have been illustrated and described, numerous modifications and variations are still possible without departing from the scope of the invention. The scope of the invention is limited by the accompanying claims.

1. A hollow fiber membrane filtration device comprising:
a housing including a receiving space having a bottom opening, wherein the housing further includes a top wall having a positioning hole intercommunicating with the receiving space, and wherein a plurality of inlet holes is spacedly provided on a periphery of the housing and intercommunicates with the receiving space;
a hollow fiber membrane module including a plurality of hollow fibers which are densely arranged, wherein each of the plurality of hollow fibers is substantially inverted U-shaped and includes two open ends facing downwardly and inserted into and fixed to a fiber membrane seat, wherein the hollow fiber membrane module is inserted upward through the bottom opening into the receiving space, and wherein the fiber membrane seat is fixed in the bottom opening;
a supporting tube having a lower end inserted in the fiber membrane seat and extends upright to couple with the top wall of the housing, wherein the supporting tube includes a central hole aligned with the positioning hole of the top wall of the housing, forming a fixing hole for installation, wherein the plurality of hollow fibers is densely distributed around an outer periphery of the supporting tube;
a bottom cover coupled to the bottom opening of the housing, wherein the bottom cover includes a flow guiding space having an upwardly facing opening, and wherein the bottom cover includes a bottom having an outlet facing and spaced from the central hole of the supporting tube,
wherein a fluid is permitted to flow through the plurality of inlet holes of the housing and a periphery of each of the plurality of hollow fibers and infiltrates into an interior of each of the plurality of hollow fibers, and the fluid then flows downward through the two open ends of each of the plurality of hollow fibers into the flow guiding space of the bottom cover and flows downward and outward through the outlet of the bottom cover.

2. The hollow fiber membrane filtration device as claimed in claim 1, wherein the housing includes a first inner threading on an inner wall of the bottom opening of the housing, wherein the fiber membrane seat includes a first outer threading on an outer periphery thereof, and wherein the first outer threading is in threading connection with the first inner threading.

3. The hollow fiber membrane filtration device as claimed in claim 2, wherein the housing includes a second outer threading on an outer periphery of the bottom end of the housing, and wherein the bottom cover includes an inner wall having a second inner threading in threading connection with the second outer threading.

4. The hollow fiber membrane filtration device as claimed in claim 3, wherein the fiber membrane seat includes an inner ring and an outer ring concentric to and radially outward of the inner ring, and wherein the plurality of hollow fibers is juxtaposedly adhered between the inner ring and the outer ring.

5. The hollow fiber membrane filtration device as claimed in claim 4, wherein the inner ring of the fiber membrane seat includes an inner side having a third inner threading, and wherein a third outer threading is provided on the outer periphery of the supporting tube and is in threading connection with the third inner threading.

6. The hollow fiber membrane filtration device as claimed in claim 1, wherein the housing includes an enlarged stepped hole below the positioning hole, wherein a top end of the supporting tube is coupled in the enlarged stepped hole, and wherein the central hole of the supporting tube and the positioning hole have a same diameter.

7. The hollow fiber membrane filtration device as claimed in claim 1, further comprising a filtration seat having a fixing rod disposed in a central portion thereof, wherein the bottom cover is inserted in the filtration seat, wherein the fixing rod extends upward through the outlet of the bottom cover, the central hole of the supporting tube, and the positioning hole of the housing, wherein the fixing rod has an outer diameter matching with the diameters of the central hole of the supporting tube and the positioning hole, and wherein a diameter of the outlet of the bottom cover is greater than the outer diameter of the fixing rod.
